(19) United States
(12) Patent Application Publication
(10) Pub. No.: US 2021/0031240 A1
(43) Pub. Date: Feb. 4, 2021

(54) SORTING SYSTEM

(71) Applicant: Siemens Logistics LLC, DFW Airport, TX (US)

(72) Inventor: Michael D. Carpenter, Arlington, TX (US)

(21) Appl. No.: 16/524,642

(22) Filed: Jul. 29, 2019

(51) Int. Cl. B07C 5/36

(52) U.S. Cl. CPC B07C 5/362

(57) ABSTRACT

A transportation and sorting system for packages includes a plurality of bins arranged to receive the packages, each bin having a separate sort criteria, an autonomous guided vehicle (AGV) operable to carry a first package from an induction point to any of the plurality of bins, and a sensor coupled to the AGV and operable to measure a value for each bin indicative of that bin's capacity to hold additional packages. A computer system is operable to read the first package to determine which bin of the plurality of bins should receive the first package and to instruct the AGV to deliver the first package to that bin. The computer system is also operable to provide an indication when the value for one of the plurality of bins indicates that that bin has a capacity to hold additional packages that is below a predetermined level.

### TECHNICAL FIELD

The present disclosure is directed, in general, to a mail or package sorting system, and more specifically to a mail or package sorting system including autonomous guided vehicles (AGVs).

### BACKGROUND

Processing of packages for delivery is typically accomplished manually or using conveyor and diverter systems depending upon the volume of the sorting. For low volume sorting, manual sorting may be sufficient. However, high-volume sorting requires the conveyor and diverter systems. These convertor and diverter systems can be very expensive which might make them cost-prohibitive or inefficient for sorting operations of medium volume.

In addition, as parcels have become more common, processing has become even more difficult. Most facilities were designed for the processing of letters and flats (e.g., magazines, brochures, etc.), which can be done relatively efficiently in terms of labor and space with manual labor. However, sorting, accumulating, and distributing parcels is far more difficult, with orders of magnitude more space required, and significantly lower productivity in sorting.

### SUMMARY

A transportation and sorting system for packages includes a plurality of bins arranged to receive the packages, each bin having a separate sort criteria, an autonomous guided vehicle (AGV) operable to carry a first package from an induction point to any of the plurality of bins, and a sensor coupled to the AGV and operable to measure a value for each bin indicative of that bin's capacity to hold additional packages. A computer system is operable to read the first package to determine which bin of the plurality of bins should receive the first package and to instruct the AGV to deliver the first package to that bin. The computer system is also operable to provide an indication when the value for one of the plurality of bins indicates that that bin has a capacity to hold additional packages that is below a predetermined level.

In another construction, a transportation and sorting system for packages includes a plurality of bins arranged to receive the packages, each bin having a separate sort criteria, and a plurality of autonomous guided vehicles (AGVs) each having a base portion, an intermediate portion, and a parcel support portion, a first parcel support portion of a first AGV including a first movable delivery mechanism operable to carry a first package from an induction point to any of the plurality of bins and a second movable delivery mechanism operable to carry a second package from the induction point to any of the plurality of bins. An identification module is operable to read the first package and the second package to determine a first desired bin for the first package and a second desired bin for the second package and operable to transmit the desired bin information to the first AGV.

In another construction, a transportation and sorting system for packages includes a plurality of bins arranged to receive the packages, each bin having a separate sort criteria, a plurality of autonomous guided vehicles (AGVs) each having a battery and a parcel support portion including a first movable delivery mechanism and a second movable delivery mechanism, and an identification module operable to read each package to determine a parameter indicative of a sort location for each package. A computer is operable to receive the parameter from the identification module for each package and to determine the sort location for each package and a loop includes a first induction point and a charging region, each of the plurality of bins disposed adjacent the loop, each AGV movable about the loop and supporting a first package on the first movable delivery mechanism and a second package on the second movable delivery mechanism as it enters the loop at the first induction point, the computer communicating the sort location for each of the first package and the second package to the AGV.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this specification and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 is a schematic illustration of a prior art conveyor and diverter sorting system for use in high-volume sorting applications.

FIG. 2 is a schematic illustration of a sorting and transportation system including at least one autonomous guided vehicle (AGV).

FIG. 3 is a perspective view of an AGV including a parcel support portion having two independent delivery mechanisms.

FIG. 4 is a perspective schematic view of an alternative parcel support portion having two independent delivery mechanisms.

FIG. 5 is a schematic illustration of the operation and use of one of the delivery mechanisms of the parcel support portion of FIG. 4.

FIG. 6 is a perspective view of a portion of the system of FIG. 2 including an AGV having the parcel support portion of FIG. 4 and including a bin sensor.

FIG. 7 is a perspective view of a portion of the system of FIG. 2 including AGVs having the parcel support portion of FIG. 3.

FIG. 8 is a schematic illustration of the operation and use of another delivery mechanisms for a parcel support portion.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard as available a variation of 20 percent would fall within the meaning of these terms unless otherwise stated.

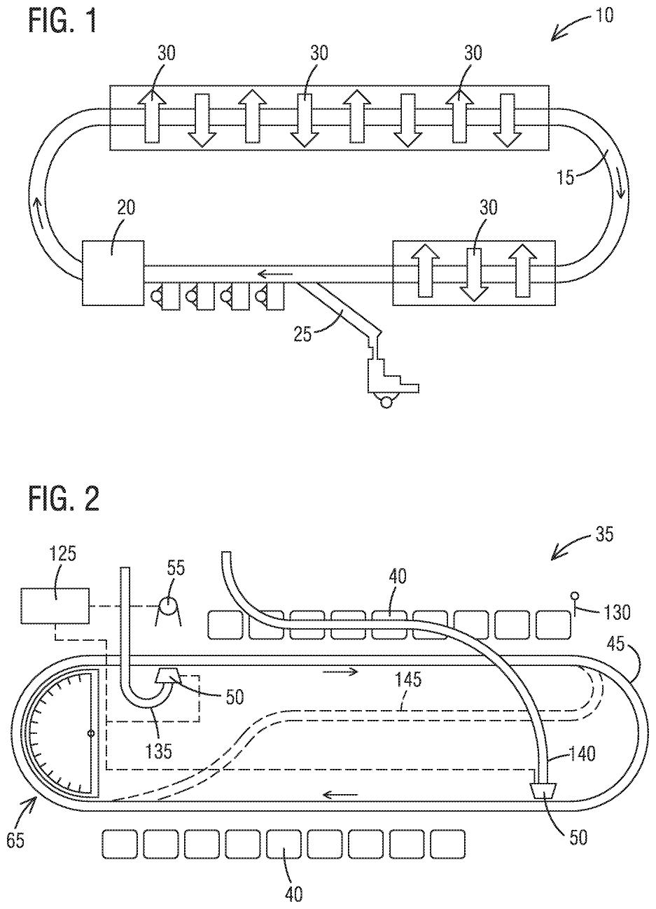

FIG. 1 schematically illustrates a known system 10 for sorting a high-volume of packages. The system 10 includes a fixed conveyor 15 that moves through an oval to move the packages or items as desired. An identification module 20 is positioned on the conveyor 15 at a point immediately following an area where new packages are introduced (an induction point 25) and operates to identify the package and/or the destination of that package. In most constructions, barcode readers are employed. However, other devices such as RFID readers could be employed to identify the package or its destination. Once identification is complete, the packages move to one or more sorting areas where diverters 30 or other devices are used to push or divert the package from the main conveyor 15 into a bin or onto another conveyor. FIG. 1 illustrates different diverters 30 as orthogonal arrows positioned over the conveyor 15. In some constructions, the diverters 30 push the packages into bins that are manually or automatically removed when full. As such, each bin requires a sensor that determines how full the bin might be.

In low-volume sorting operations, manual sorting may be possible. In these systems, a user manually presents each item to a barcode reader or other identifying device that identifies the package and/or the destination of the package. The user then manually deposits each item into a container designated according to the barcode result. Productivity is relatively low and scaling to accommodate seasonal fluctuations in volume (e.g., the Christmas season) requires additional workers to maintain the necessary throughput.

As a particular sorting operation transitions from low-volume towards high-volume it transitions through a medium-volume range where manual sorting is simply impractical and conveyor and diverter sorting is cost, space, or otherwise prohibitive.

FIG. 2 schematically illustrates a portion of a transportation and sorting system 35 that is well-suited to applications with medium volume or that requires operation during only short periods each day. As illustrated in FIG. 2, the system 35 includes a plurality of bins 40 each arranged to receive packages that have some sorting feature in common. For example, each bin 40 might receive packages for delivery by a particular postal worker in a particular area or may have the same zip code. The bins 40 are illustrated as being arranged on an oval path, circuit, or loop 45 but could be arranged in any manner or along any shaped path desired so long as the path eventually forms a closed loop.

In preferred constructions, the bins 40 are canvas-walled wheeled containers but could include virtually any type of bin or container desired. In addition, rather than bins 40, the system could deposit packages onto a pallet or other movable object or could deposit the packages on another conveyor system for further distribution or sorting.

Autonomous guided vehicles (AGVs) 50 move along the path 45 autonomously to deliver packages to the appropriate bins 40. While the AGVs 50 are illustrated as following a pre-determined path 45, one of ordinary skill would realize that AGVs 50 could move directly to the desired bin 40 following the shortest path possible if desired. In addition, the path 45 could include multiple lanes or bypass paths that can speed the movement of AGVs 50. For example, the path or circuit 45 could include a delivery lane where AGVs 50 periodically stop to deliver packages and a passing lane where AGVs 50 that do not need to stop can travel. AGVs 50 could change lanes as necessary to make deliveries. In still another arrangement, the path 45 includes periodic exits that lead directly back to the point where packages are placed on the AGVs 50, to a charging area 65, or to another desired location. It should be clear that many different paths and arrangements could be employed as desired.

Each of the AGVs 50 includes a control system that allows it to avoid collisions with other objects or AGVs 50. In the least expensive and simplest system, the AGVs 50 are programmed to follow the fixed path 45 with the bins 40 all positioned on that path 45 to receive the packages. Constructions that provide for point-to-point travel of the AGVs 50 are generally more efficient than systems that follow a fixed path or circuit 45. However, the AGVs 50 employed are generally costlier as they require more accurate and complex control systems to assure proper navigation and movement. Systems that use a fixed path 45 can be simpler but as the available paths become more complex, the control system must also become more complex.

A number of systems can be employed to identify the bins 40 for each AGV 50. For example, active or passive RFIDs could be employed at each bin location to properly identify each bin 40 for the AGVs 50. In another construction, GPS coordinates are employed, with still other constructions using barcode readers or other optical devices to determine which bin 40 is adjacent an AGV 50. As one of ordinary skill in the art will realize, a number of different systems can be employed to uniquely identify each bin 40 for the AGVs 50.

Each AGV 50 receives its package or packages from a pallet, a presorter or some other device and is instructed on where to deliver each package. More specifically, the system 35 of FIG. 2 includes an identification module 55 similar to that discussed with regard to FIG. 1. Once the AGV 50 is loaded and instructed as to where to deliver the package or packages, the AGV 50 proceeds along the path 45 to the bins 40. It should be noted that each AGV 50 could be equipped to determine where each package should be delivered. In this case, the identification module 55 is not required. Rather, each package is placed on an AGV 50 which then reads the package (e.g., barcode reader, RFID, etc.) to determine where that package should be delivered.

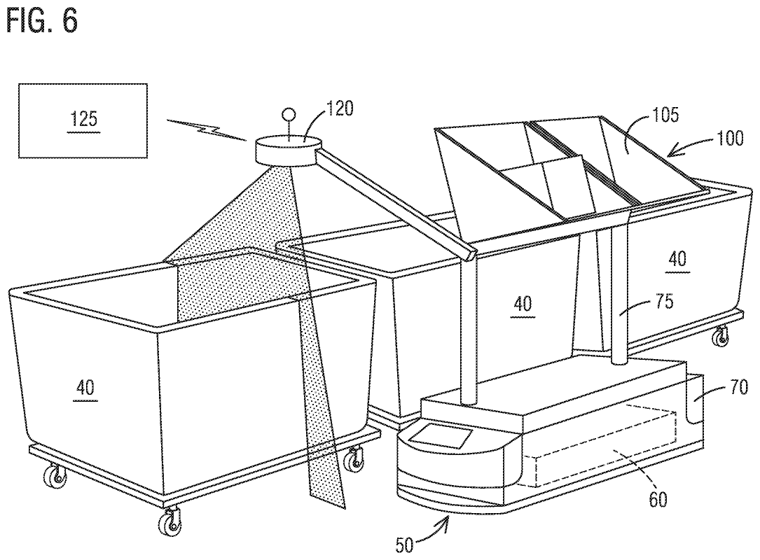

Each AGV 50 is preferably powered using rechargeable batteries 60 (shown in FIG. 6) or other rechargeable energy storage devices (e.g., ultracapacitors, solar power systems, etc.). The AGVs 50 could employ induction charging systems that allow for charging when the AGV 50 is positioned within or moving through a charging area 65 or could be charged continuously as the AGV 50 moves along the path 45. Alternatively, each AGV 50 includes contacts that are engaged with a charging system in charging bays provided in the charging area 65. When the AGV 50 needs charging, it pulls into one of the unoccupied bays, the contacts engage and the AGV 50 is charged. In yet another construction, operators plug the AGVs 50 in when not in use to allow charging. It should be noted that while FIG. 2 illustrates a single charging area 65, other constructions could include multiple charging areas as desired.

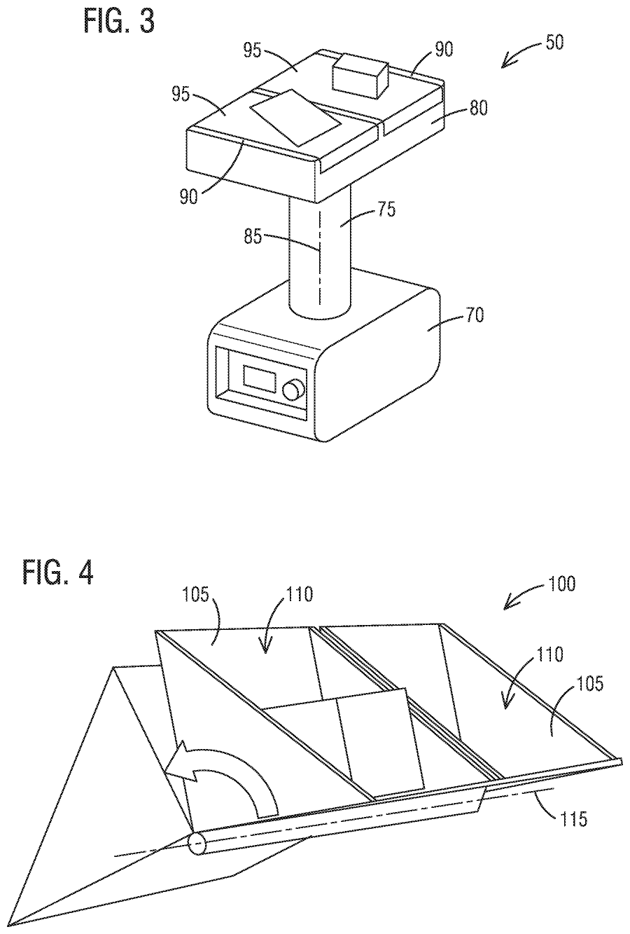

FIG. 3 illustrates one suitable AGV 50 for use in the system 35 of FIG. 2. The AGV 50 includes a base portion 70, an intermediate portion 75, and a parcel support portion 80. The base portion 70 contacts the floor and includes any drive motors, batteries 60, or other energy storage devices. A track drive, a wheel drive, or another drive system may be employed to propel the AGV 50 along the ground. Sensors and an AGV 50 controller may also be disposed within the base portion 70. The sensor or sensors can determine the current position (e.g., GPS) of the AGV 50 as well as determine if there are any obstacles in the AGV's path (e.g., RADAR, LIDAR, etc.). Typically, the controller is provided with, and contains information necessary to deliver the package or packages to the proper destination. In the construction illustrated in FIG. 2, the identification module 55 instructs each AGV controller regarding where the packages should be delivered.

The intermediate portion 75 extends from the base portion 70 to the parcel support portion 80 and is sized to assure that the parcel support portion 80 is capable of delivering parcels at a desired height and position. In some constructions, the intermediate portion 75 contains an actuator or motor capable of rotating the parcel support portion 80 about a vertical axis 85. In the AGV 50 illustrated in FIG. 3, rotation of only ninety degrees could allow for the delivery of a package in any 360 direction around the vertical axis 85.

The parcel support portion 80 is arranged to support one or more parcels for transportation from the identification module 55 to the proper bin 40 and to deliver that parcel safely into the bin 40. The quantity of parcels supported by the parcel support portion 80 is largely determined by the size and type of parcels. In the illustrated construction, the parcel size is conducive to a parcel support portion with two delivery mechanisms 90. Other constructions may only be capable of handling a single parcel or may include three or more delivery mechanisms 90. In addition, systems 35 that have widely varying parcel sizes, can employ different AGVs 50 having different sizes and quantities of delivery mechanisms 90.

The delivery mechanisms 90 of the AGV 50 of FIG. 3 each include a horizontal conveyor 95 on which is positioned the parcel. In the illustrated construction, the conveyors 95 are arranged as cross-belt carriers mounted at a height above the floor to allow them to direct items into repositories or bins 40. When the AGV 50 is positioned adjacent the correct bin 40, the AGV controller activates the correct delivery mechanism 90 in the form of the conveyor 95, in the correct direction, and the parcel is delivered to the bin 40. In preferred constructions, the conveyor movement is bi-directional such that deliveries to either side of the AGV 50 can be accommodated. In constructions in which the intermediate portion 75 can rotate, the parcels could be delivered toward the front or rear of the AGV 50 in addition to the sides using only the two-direction conveyor 95 illustrated.

In some constructions, the conveyor 95 is also supported in a manner that allows for tilting. Tilting downward toward the bin 40 (i.e., the opposite end tilting upward) into which the parcel is being deposited can enhance the accuracy of the delivery and reduce the likelihood of missing the bin 40. In still other constructions, the conveyor 95 is eliminated and is replaced with a tilting platform. For heavier parcels, gravity alone may be sufficient to deliver the package from a tilting platform.

FIG. 4 illustrates an alternative parcel support portion 100 that is arranged to contain larger parcels or more oddly shaped parcels than might be transported on the parcel support portion 80 of FIG. 3. The parcel support portion 100 of FIG. 4 includes two independently rotatable or tiltable containers 105 that include walls arranged to contain the parcel within a more enclosed space. When in the transport position, illustrated in FIG. 4, an open portion 110 of the container 105 faces substantially upward and the container 105 contains the parcel. When the container 105 is rotated or tilted clockwise about its pivot axis 115 (parallel to the floor), the open portion 110 faces downward, and the parcel falls from the container 105 into the bin 40.

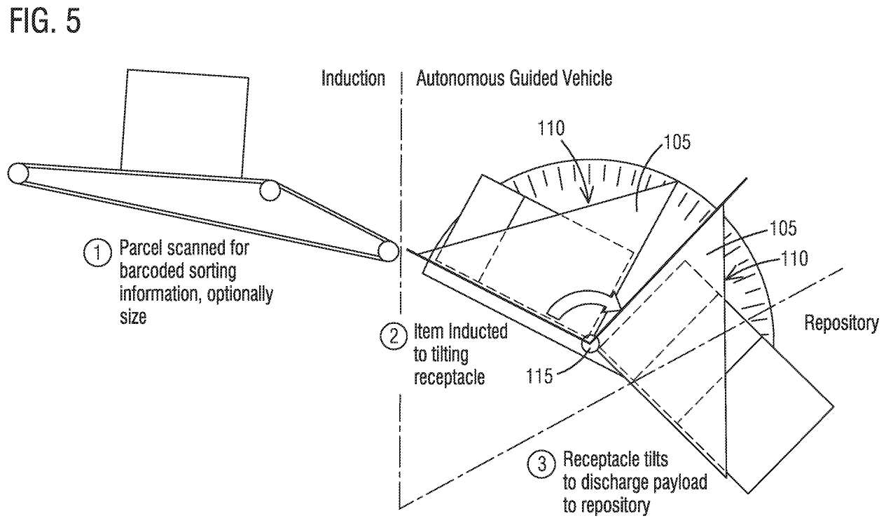

FIG. 5 better illustrates the use of the parcel support portion 100 of FIG. 4 from the receipt of a package to its delivery to the bin 40 or other device. As illustrated, the parcel is first scanned (read) for a barcode or other identification device to determine where the package to be delivered. The package moves down the conveyor and into one of the containers 105 of the AGV 50. When the AGV 50 arrives at the bin 40 to which the package is to be delivered, the container 105 rotates or tilts to direct the open face 110 of the container 105 downward to allow the parcel to fall into the bin 40.

FIG. 8 illustrates another arrangement of the parcel support portion 100 that could be used in the construction of FIG. 6 and that allows for the receipt and discharge of packages from either side of the AGV 50. In FIG. 8, the container 105 is illustrated in a first or transport position 150 in which its open face 110 is directed upward. Four shadowed images are shown illustrating the four additional positions the container 105 can occupy. During the loading process, the AGV 50 carrying the parcel support portion 100 could be positioned in a way that allows the parcel to be loaded from either the left side or the right side as shown in FIG. 8. If the package is coming from the right side, the container 105 is moved into a second or right-receiving position 155. In this position, the open face 110 of the container 105 faces slightly to the right to allow for the easier placement of the package in the container 105. When the package is being delivered from the left side, the container 105 is rotated to a third or left-receiving position 160 where the open face 110 of the container 105 faces slightly to the left to allow for the easier placement of the package into the container 105. Once the container 105 receives the package, it moves to the transport position 150 for transport to the desired bin 40. Once the AGV 50 arrives at the bin 40, the container 105 is rotated or tilted to one of two discharge positions. A discharge-right or fourth position 165 allows the package to be discharged to the right side of the AGV 50 and a discharge-left or fifth position 170 allows the package to be discharged to the left side of the AGV 50. It should be noted that another construction could include the parcel support portion 100 described with regard to FIG. 8, or the parcel support portion described with regard to FIG. 5, mounted on a rotatable intermediate portion 75. As previously described, these arrangements would allow for the loading and unloading of packages from any position around the AGV 50. The use of a tiltable or rotatable container 105 is advantageous as the container 105 itself provides guides that are built into the container 105 that aid in the accurate delivery of the parcel into the bin 40.

As with the first arrangement of the parcel support portion 80, the second parcel support portion 100 can include only a single container 105 or could include three or more containers 105 depending on the desired size of the containers 105 as well as the expected size of the packages and the size of the AGV 50. It should also be clear that there is no requirement that each of the delivery mechanisms 90 of an AGV 50 be of the same type or design. For example, one AGV 50 could include a conveyor delivery mechanism 95 such as the one illustrated in FIG. 3 immediately adjacent a container delivery mechanism 105 such as the one illustrated in FIG. 4. In addition, other designs or delivery mechanisms could be employed.

To further enhance the system 35 of FIG. 2, one or more of the AGVs 50 can be equipped with a sensor 120, shown in FIG. 6, that operates to measure a parameter indicative of the remaining volume or the quantity contained in each bin 40 as it passes the bin 40. The measured parameter could then be transmitted wirelessly or otherwise transferred to a central control system or computer 125 to assure that the bin 40 is switched before it is full and is not overfilled. For example, as the AGV 50 is receiving a new package, it can deliver its measurement results from its previous delivery thereby allowing the central control system 125 to control the flow of the bins 40. A more accurate system immediately transfers the data for each bin 40 upon measurement.

Sensors 120 such as laser scanners, ultrasonic scanners, image analysis systems, time-of-flight sensors, and the like can be employed to determine the level of contents within the bin 40 being measured. The use of a single sensor 120 on one of the AGVs 50 within the system of FIG. 2, several of the AGVs 50, or all the AGVs 50 allows for very accurate and inexpensive measurement of the various bins 40 to assure that no bin 40 becomes overfilled. In a group of AGVs 50 working a circuit or loop 45, at least one of the AGVs 50 should be fitted with a configuration of sensors 120 to measure the remaining volumetric capacity in the bins 40 as it moves through the loop 45. This volumetric information for each bin 40 is transmitted to the main controlling computer 125.

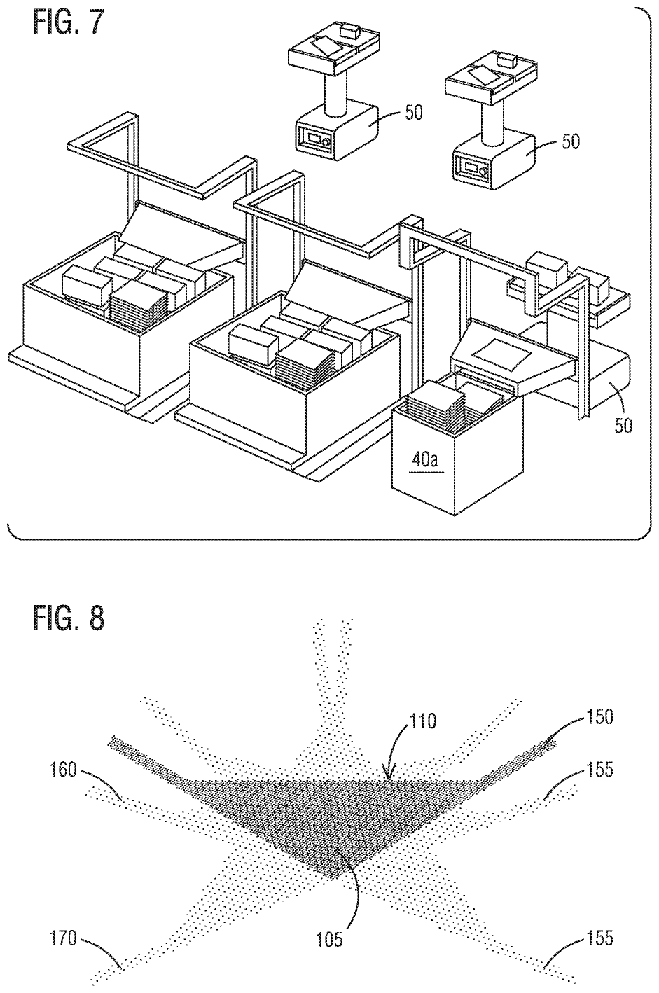

FIG. 7 illustrates a portion of the system 35 of FIG. 2 including metallic bins 40a rather than the canvas bins 40 illustrated in FIG. 6 and using the AGVs 50 and parcel support portion 80 of FIG. 3.

The main controlling computer 125 is responsible for directing each of the AGVs 50 to the proper destination based on the information scanned from the items that are being sorted. The scanning may be automatic or manual, depending on the size of the system and utilization level. Automatic scanning systems (e.g., the identification module 55) add the potential for scanning each item prior to loading as payload onto an AGV 50. The computer 125 uses the data read from each package to determine the proper bin 40 for each package. The proper bin data is transferred (wirelessly or otherwise) to the AGV 50 carrying the package to facilitate proper delivery. The main controlling computer 125 also monitors the current state of fill for each repository or bin 40 based on updates wirelessly transmitted, or otherwise received from at least one AGV 50 carrying the necessary sensors 120 to measure the storage capacity of each bin 40.

In some constructions, when the size of an item being placed on the AGV 50 exceeds the remaining volume in the target bin 40, the system 35 can notify a user or other system component (e.g., a light 130, shown in FIG. 2, indicating the bin 40 is full) that the target bin 40 needs to be replaced, and/or can assign a spare bin 40 from among a set of reserve spares. In one construction, each bin location includes a light 130 adjacent the bin position. The light 130 is close enough to its respective bin 40 to assure that a user would understand that the light 130 represents the adjacent bin 40. When the bin 40 is full or when it exceeds a predetermined percentage of occupied volume, the light 130 can be activated to indicate that the bin 40 should be changed. In still another construction, a multi-colored light system is employed. The light 130 could turn on and be yellow when the bin 40 reaches eighty percent full, with the light 130 turning red at ninety-five percent. Finally, the light 130 could flash when the bin 40 is one hundred percent full.

When the target bin 40 is full, the package can be delivered to a spare bin 40 that is ultimately moved to an induction point 135 of the system 35 and reloaded on one of the AGVs 50 after some time has passed. Presumably, the target bin 40 has been replaced and the package can be delivered.

When controlling one or more AGVs 50 on a distribution circuit or loop 45, there are different principle approaches available. The approach selected is driven by the level of navigation technology integrated into each AGV 50. In one construction, the navigation technology within the AGVs 50 allows the AGVs 50 to navigate directly from point to point, avoiding obstacles along the way, and potentially reducing the route distance. This autonomous navigation generally requires Autonomous Mobile Robots, or AMRs for use as AGVs 50.

Another AGV technology requires the vehicle to follow magnetic tape in a predetermined circuit 45, with fewer opportunities to reduce circuit length. Circuit length is important because it is directly proportional to the number of AGVs 50 or AMRs required, and the time of operation required to perform a particular task.

The same sensitivities are apparent when considering the number of items taken as payload by each AGV 50 in a single loop 45. This is the factor that adds advantage to having more than one delivery mechanism 90 per AGV 50. Another way to invoke this improvement is to include multiple induction points 135 along the loop 45 for the introduction of AGVs 50 carrying packages, with either an automatic or manual presort upstream of the induction point 135. For example, in one simple sorting system, items are sorted into bins 40 alphabetically. A first induction point 135 may be placed immediately upstream of the “A” bin 40. The addition of a second induction point 140 between the “M” bin 40 and the “N” bin 40 could cut the travel time of each AGV 50 significantly. A presort would be required to assure the proper items are added to AGVs 50 at the proper induction point 135, 140 but, in exchange, each AGV 50 travels through only half the alphabet.

FIG. 2 illustrates one example of the system 35 described above as it would be implemented at a delivery unit (DU) in the U.S. postal system. As background to this example, postal agencies have introduced “Work Sharing” programs whereby customers introduce batches of items to be delivered deeply into the postal distribution network (toward the destination), whereby the processing costs of the postal agency can be greatly reduced, and a portion of this savings can be passed along to the originator in the form of discounts on the delivery fee. The deepest discounts are offered in cases in which the items to be delivered are injected at the final processing step, often referred to as “the last mile (1.61 kilometers)”.

The final processing or sorting step, schematically illustrated in FIG. 2, begins at the postal delivery unit (DU); the base from which postal carriers make their deliveries. The approach of performing the final sort at the DU has been common for many years, typically done by hand, in the processing and delivery of mail such as letters or flats (magazine-sized items) but has more recently become a major factor in the delivery of goods (parcels) by postal agencies.

The processing that occurs at the DU is focused on the distribution of items to be delivered among the carriers that will deliver them. Thus, each bin 40 in FIG. 2 might represent a single carrier and may include that carrier's deliveries for the day. The number of carriers in a single DU may be relatively few in rural areas, but typical DUs include between 30 and 70 carriers. The operation of distributing items to be delivered among the carriers that will make the deliveries must be completed between the time that the items arrive from upstream processing, either internally or externally, and the time at which carriers need to begin their deliveries, which is often defined by the imperative of having carriers on the road prior to rush hour traffic, and the need to complete deliveries within a typical workday's duration. These framing milestones leave a relatively short processing time of three to four hours each day during which the work must be completed. Efforts to automate operations at the delivery unit have been frustrated by the low utilization that the operating window defines which makes many automated processes, such as the one illustrated in FIG. 1 cost prohibitive.

As discussed, the process illustrated in FIG. 2 addresses the issues discussed with regard to the final sorting process at the DU. Specifically, parcels from users that have complied with the postal services presorting requirements are delivered directly to the DU. The packages are removed from the pallets or other devices on which they are delivered and are placed on AGVs 50. Each package is read by the identification module 55, either prior to or after placement on the AGV 50 and the sort location is provided to the AGV 50 by the central computer 125 for each package or parcel the AGV 50 carries. The AGV 50 then enters the loop 45 at the first induction point 135 upstream of each of the bins 40. If the AGV 50 includes sensors 120 for measuring the empty volume of the bins 40, it can measure each bin 40 as it passes and transfer that data either wirelessly or through a wired connection (e.g., floor mounted communication) to the central computer 125. When the AGV 50 arrives at the bin 40 into which it is supposed to deposit the parcel, the AGV 50 positions itself as required and delivers the parcel. A video system, or other system can be employed to verify that the package is delivered to the bin 40. Alternatively, other sensors could be employed to verify that the package was delivered (e.g., volume sensors such as those previously described, weight sensors could measure the weight change of the bin 40, etc.). The AGV 50 then continues along the circuit, path, or loop 45 to deliver any additional packages as may be required. If the AGV 50 requires charging, it can stop in the charging area 65 after delivering the packages to recharge its batteries 60 as described above.

With continued reference to FIG. 2, packages that are presorted can also utilize the second induction point 140 to further speed processing. For example, if each bin 40 represents a certain zip code, the presort could simply move the higher zip codes to the second induction point 140. Once placed on an AGV 50, the same process described above is followed but the AGV 50 only needs to pass half (or some desired percentage) of the bins. Additional paths 145 can be provided to allow AGVs 50 to bypass the portions of the circuit 45 adjacent the bins 40 that are not part of the presorted region to which the AGV 50 is delivering packages.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A transportation and sorting system for packages, the system comprising:
a plurality of bins arranged to receive the packages, each bin having a separate sort criteria;
an autonomous guided vehicle (AGV) operable to carry a first package from an induction point to any of the plurality of bins;
a sensor coupled to the AGV and operable to measure a value for each bin indicative of that bin's capacity to hold additional packages; and
a computer system operable to read the first package to determine which bin of the plurality of bins should receive the first package and to instruct the AGV to deliver the first package to that bin, the computer system also operable to provide an indication when the value for one of the plurality of bins indicates that that bin has a capacity to hold additional packages that is below a predetermined level.

2. The transportation and sorting system of claim 1, wherein the sort criteria includes a zip code.

3. The transportation and sorting system of claim 1, wherein the AGV includes a parcel support portion including a first movable delivery mechanism and a second movable delivery mechanism.

4. The transportation and sorting system of claim 3, wherein the first movable delivery mechanism includes a conveyor belt operable to move the first package off the parcel support portion.

5. The transportation and sorting system of claim 3, wherein the first movable delivery mechanism includes a tiltable portion operable to discharge the first package.

6. The transportation and sorting system of claim 5, wherein the tiltable portion includes a container that is tiltable about a pivot axis that is parallel to the floor.

7. The transportation and sorting system of claim 5, wherein the tiltable portion is tiltable to any one of a transport position, a first side receive position, a first side discharge position, a second side receive position, and a second side discharge position.

8. The transportation and sorting system of claim 1, wherein the sensor is one of a laser sensor, an ultrasonic sensor, and a time-of-flight sensor.

9. The transportation and sorting system of claim 1, wherein the indication includes a light disposed adjacent the bin.

10. A transportation and sorting system for packages, the system comprising:
a plurality of bins arranged to receive the packages, each bin having a separate sort criteria;
a plurality of autonomous guided vehicles (AGVs) each having a base portion, an intermediate portion, and a parcel support portion, a first parcel support portion of a first AGV including a first movable delivery mechanism operable to carry a first package from an induction point to any of the plurality of bins and a second movable delivery mechanism operable to carry a second package from the induction point to any of the plurality of bins; and
an identification module operable to read the first package and the second package to determine a first desired bin for the first package and a second desired bin for the second package and operable to transmit the desired bin information to the first AGV.

11. The transportation and sorting system of claim 10, wherein the first movable delivery mechanism includes a conveyor belt operable to move the first package off the parcel support portion.

12. The transportation and sorting system of claim 10, wherein the first movable delivery mechanism includes a tiltable portion operable to discharge the first package, and wherein the tiltable portion includes a conveyer that is tiltable about a pivot axis that is parallel to the floor.

13. The transportation and sorting system of claim 12, wherein the tiltable portion is tiltable to any one of a transport position, a first side receive position, a first side discharge position, a second side receive position, and a second side discharge position.

14. The transportation and sorting system of claim 10, wherein the identification module reads a first barcode on the first package and a second barcode on the second package, and wherein the identification module communicates with a computer which receives the first barcode data and the second barcode data from the identification module and determines the first desired bin based at least in part on the first barcode data and determines the second desired bin based at least in part on the second barcode data, and wherein one of the computer and the identification module communicates the first desired bin and the second desired bin to the first AGV.

15. A transportation and sorting system for packages, the system comprising:
a plurality of bins arranged to receive the packages, each bin having a separate sort criteria;
a plurality of autonomous guided vehicles (AGVs) each having a battery and a parcel support portion including a first movable delivery mechanism and a second movable delivery mechanism;
an identification module operable to read each package to determine a parameter indicative of a sort location for each package;
a computer operable to receive the parameter from the identification module for each package and to determine the sort location for each package; and
a loop including a first induction point and a charging region, each of the plurality of bins disposed adjacent the loop, each AGV movable about the loop and supporting a first package on the first movable delivery mechanism and a second package on the second movable delivery mechanism as it enters the loop at the first induction point, the computer communicating the sort location for each of the first package and the second package to the AGV.

16. The transportation and sorting system of claim 15, wherein the first movable delivery mechanism includes a conveyor belt operable to move the first package off the parcel support portion.

17. The transportation and sorting system of claim 15, wherein the first movable delivery mechanism includes a tiltable portion tiltable about a pivot axis that is parallel to the floor and operable to discharge the first package.

18. The transportation and sorting system of claim 17, wherein the tiltable portion is tiltable to any one of a transport position, a first side receive position, a first side discharge position, a second side receive position, and a second side discharge position.

19. The transportation and sorting system of claim 15, further comprising a sensor attached to and movable with one of the AGVs, the sensor operable to measure a value for each bin that is indicative of an available volume in each bin.

20. The transportation and sorting system of claim 19, wherein the sensor provides a user identifiable indication for each bin determined to have the available volume below a predefined level.
